(19) United States
(12) Patent Application Publication
(10) Pub. No.: US 2021/0386084 A1
(43) Pub. Date: Dec. 16, 2021

(54) KIT FOR FERMENTING PLANT MILKS

(71) Applicant: BRIN DE FOLI, Vic Le Comte (FR)

(72) Inventor: David TROPEL, Vic Le Comte (FR)

(21) Appl. No.: 17/281,879

(22) PCT Filed: Sep. 30, 2019
(86) PCT No.: PCT/EP2019/076391

§ 371 Date: Mar. 31, 2021

(30) Foreign Application Priority Data
Oct. 1, 2018 (FR) 1859053

(51) Int. Cl. A23C 11/10; A23L 29/238; A23L 29/212; A23L 25/00; A23L 29/244; A23L 29/269

(52) U.S. Cl. CPC A23C 11/106; A23L 29/238; A23L 29/212; A23L 25/40; A23Y 2220/15; A23L 29/269; A23V 2002/00; A23Y 2240/75; A23L 29/244

(57) ABSTRACT

The present invention relates to a fermentation kit for the home preparation of plant juice fermentation products, also called plant-based milks, in particular fermented milks or liquid, stirred or firm yogurts, with ferments and at least one texture agent miscible with water at a temperature of 10° C. to 30° C.

### FIELD OF THE INVENTION

The present invention relates to a fermentation kit for the home preparation of plant juice fermentation products, also called plant-based milks, in particular fermented milks or liquid, stirred or firm yogurts.

### BACKGROUND ART

Consumers have a known interest in replacing dairy products with products based on plant-based milks, either because of food intolerances for dairy products, cow's milk in particular, or to vary their diet or for vegetarian or vegan diets.

There are plant-based milks of all origins (soy, quinoa, rice, sesame, almond, coconut, oat, hemp, hazelnut, spelt, buckwheat, multigrain, etc.), prepared by the disintegration of plant materials (Plant-based milk alternatives an emerging segment of functional beverages: a review. Swati Sethi & al. Food Sci Technol (2016) 53(9):3408-3423). The multiplicity of plant sources and plant-based milk preparation processes creates a wide variety of plant-based milks.

Commercially available fermented products prepared industrially from these plant sources are limited in number and highly standardized, essentially soy yogurts, which do not reflect the variety of plant-based milks available.

The alternative to this limited range of products available commercially consists in preparing one's choice of fermented products oneself. However, although the home manufacture of cow's milk yogurts is easy and well known, in particular by the use of home yogurt makers that facilitate the conditions for fermenting dairy products, it is not easy today to prepare fermented products from plant-based milks, particularly for plant-based milks other than soy milk.

Indeed, the products obtained by adding lactic ferments to plant-based milks are heterogeneous, with a solid phase and a translucent liquid phase, which when mixed leads to a granular product without a texture thickness very far removed from its equivalents obtained from animal milks.

Industrial solutions involve several steps of physical processes, of addition of texturants and of heating and cooling phases prior to fermentation. This is also what is recommended for certain recipes of plant yogurts associated with kits for use with home yogurt makers that require a more complex preparation prior to fermentation than for the preparation of yogurts based on mammalian milk.

Therefore, there is a need have fermentation kits that make it possible to obtain plant-based milk fermented products with a texture similar to that of the products obtained by fermentation of dairy products (such as fermented milk, liquid yogurt, stirred yogurt and firm yogurt), for simple home preparation, especially in home yogurt makers for which it is not necessary to apply a prior physical (pressure, shearing, strong mixing, etc.) and/or thermal treatment to promote the dispersion of texturants when adding them, there are no excessively rapid texturant effects which can block fermentation or lead to the formation of lumps and there is no mixing system during fermentation (in a yogurt maker), and therefore the risk of obtaining a heterogeneous product with a sedimentation of texturants which set too slowly.

The invention solves this problem.

### DISCLOSURE OF THE INVENTION

The present invention relates to a fermentation kit for the home preparation of plant-based milk fermentation products, which makes it possible i) to thicken the preparation to keep the texturants suspended and allow fermentation to take place and ii) while preserving the action of temperature, fermentation and acidification on the texturing of the final product.

The kit according to the invention comprises ferments and at least one texture agent miscible with water at a temperature of 10° C. to 30° C.

This kit allows a single-step preparation (addition of the ferment and the texturant simultaneously (not sequentially) without the need for heating to solubilize and/or thicken before starting the fermentation in the yogurt maker), is suitable for all plant-based milks (a universal solution) and does not require any other ingredients to obtain the desired texture (no fat, vegetable cream, etc.).

The invention also relates to a process for preparing a plant-based milk fermentation product which comprises the steps of a) adding the ferments and the texture agent(s) miscible with water at a temperature of 10° C. to 30° C. to an appropriate amount of plant-based milk, then b) distributing the mixture obtained into containers suitable for the yogurt maker fermentation step, then c) fermentation, step a) of mixing being carried out at room temperature and the amount of texture agent is comprised from 0.1 g to 3 g of texture agent per 100 ml of fermented milk.

### DETAILED DESCRIPTION OF THE INVENTION

Milk fermentation products are well known, in particular fermented milks or liquid, stirred or firm yogurts. The object of the invention is to provide a kit that allows anyone to prepare, in a single step and without any other ingredients, plant-based milk fermentation products of a consistency similar to that obtained for mammalian milk fermentation products.

According to a first embodiment, for the fermentation kit according to the invention, both the ferments and the texture agents are in individual packaging. They are not mixed.

Advantageously, they are dosed for a single use, suitable for the preparation of a fermented product in a home yogurt maker. They can also be offered in multi-dose packaging.

The advantage of separate packaging of the two ingredients of the kit lies in the possibility of adapting the relative amounts of ferment and texture agent according to the product to be obtained after fermentation in the home yogurt maker and its consistency.

According to another embodiment, the ferments and the texture agents are packaged as a premix. This premix can be single or multi-dose. This “ready-to-use” packaging has the advantage of facilitating the implementation of the recipe for preparing fermentation products.

In a single-dose packaging, the ferments and texturants are advantageously dosed for the preparation of 500 mL or 1 L of fermentation products, adapted to commercialized plant-based milk packaging. Of course, the person skilled in the art will know how to modify the doses of ferments and of texturants in a single-use kit when the plant-based milks are marketed in other volumes, in particular in countries that do not use the metric system to define their volumes.

A preferred embodiment of the invention is a single-use kit that comprises ferments and texturants in the same packaging, dosed for the preparation of 500 mL or 1 L of fermentation products.

According to another embodiment of the invention, the kit comprises, in addition to the ferments and the texture agents, in individual packages or as a premix, an appropriate amount of plant-based milk. This kit with the plant-based milk is particularly suitable for single-dose packaging of the ferments and texture agents. Plant-based milks are well known to the skilled person and commercially available. Plant-based milks are well known and commercially available. Particular mention may be made of soy, quinoa, rice, sesame, almond, coconut, cashew, oat, hemp, hazelnut, millet, chestnut, spelt and buckwheat milks, and mixtures thereof. The mixtures are prepared by mixing milk or by preparing a milk from a mixture of seeds. This is referred to as multigrain milk.

The kit according to the invention works with all plant-based milks, and is more particularly adapted for quinoa, rice, sesame, almond, coconut, cashew nut, oat, hemp, hazelnut, millet, chestnut, spelt, buckwheat, brazil nut and chickpea milks, and mixtures thereof.

The ferments are well known to the skilled person, being ferments classically used for the fermentation of dairy products. Particular mention may be made of the microorganisms of the genera Lactobacillus, Bifidobacterium, Lactococcus, Leuconostoc, Pediococcus, Propionibacterium and Streptococcus.

More specifically, the species that are identified and known to be suitable for use in the manufacture of fermented dairy products are Lactobacillus acidophilus, Lactobacillus amylolyticus, Lactobacillus amylovorus, Lactobacillus animalis(d), Lactobacillus alimentarius, Lactobacillus aviaries, Lactobacillus brevis, Lactobacillus buchneri, Lactobacillus casei(e), Lactobacillus cellobiosus, Lactobacillus collinoides, Lactobacillus coryniformis, Lactobacillus crispatus, Lactobacillus curvatus, Lactobacillus delbrueckii, Lactobacillus diolivorans(f), Lactobacillus farciminis, Lactobacillus fermentum, Lactobacillus gallinarum, Lactobacillus gasseri, Lactobacillus helveticus, Lactobacillus hilgardii, Lactobacillus johnsonii, Lactobacillus kefiranofaciens, Lactobacillus kefiri, Lactobacillus mucosae, Lactobacillus panis, Lactobacillus paracasei, Lactobacillus paraplantarum, Lactobacillus pentosus, Lactobacillus plantarum, Lactobacillus pontis, Lactobacillus reuteri, Lactobacillus rhamnosus, Lactobacillus sakei, Lactobacillus salivarius, Lactobacillus sanfranciscensis, Bifidobacterium adolescentis, Bifidobacterium animalis, Bifidobacterium bifidum, Bifidobacterium breve, Bifidobacterium longum, Lactococcus lactis, Leuconostoc citreum, Leuconostoc lactis, Leuconostoc mesenteroides, Leuconostoc, pseudomesenteroides, Pediococcus acidilactici, Pediococcus dextrinicus, Pediococcus parvulus(t), Pediococcus pentosaceus, Propionibacterium acidipropionici, Propionibacterium freudenreichii and Streptococcus thermophilus.

More particularly, mention may be made of the species Streptococcus thermophilus and Lactobacillus delbrueckii bulgarii, which are used in the manufacture of mammalian milk yogurts.

The ferments are made up of the above-mentioned microorganisms alone or in mixtures.

Ferments according to the invention are understood as complex mixtures of ferments known for the traditional manufacture of fermented mammalian dairy products known in particular under the names of laban, leben, labneh, kéfir, koumiss, rayeb, dadiah, dahi, filmjölk, buttermilk, lait ribot, lassi or viili.

These ferments are packaged in powder form, according to their usual packaging method.

The ferments can be certified “organic” or adapted for the production of “vegan” foods. They are ferments produced on a plant base. Particular mention may be made of the ferments marketed under the trademarks Danisco® VEGE Culture (Dupont) or NU-TRISH® (Chr Hansen).

Texturants, also called texture agents, miscible in water from 10° C. to 30° C. are also known to the skilled person. Miscible in water means that they are soluble or rehydrate in water to form a solution or a gel in water at room temperature.

The selection of these texture agents precisely allows a home use of the kits according to the invention, with the room temperature mixing of the texture agents with the plant-based milk, without having to heat the preparation.

Room temperature is that found in a living room of a dwelling, which will depend on its latitude and the season. It is generally from 17° C. to 25° C. The mention of room temperature refers to the fact that it is not necessary to heat the plant-based milk to mix it with the texture agent before the home yogurt maker fermentation step.

Preferably, the texture agents according to the invention are miscible with water at a temperature below 25° C.

These texture agents are known to the skilled person, in particular selected from cold-soluble gums: konjac gum, guar gum, xanthan gum, karaya gum, tragacanth gum, gum arabic (or acacia gum) and tara gum; alginates; pectins and cold-soluble starches: this is the case in particular of modified starches and/or pregelatinized starches; cold-soluble plant proteins: pea protein, potato protein, rice protein, pumpkin seed protein, fava protein, etc.

The texturant agents can be used alone or in a mixture depending on the desired result.

The advantage of the invention is to be able to obtain plant-based milk fermentation products of similar consistency and appearance to those of mammalian milk fermentation products, while using a minimum of texturant agents for their manufacture. To this end, at least one cold-soluble gum and/or modified or pregelatinized starch is preferably used as texture agent.

The skilled person will know how to determine the amounts and relative proportions of each texture agent according to the plant-based milk used and the desired consistency of the fermentation product.

Advantageously, the texture agent comprises guar gum, starch (in particular modified or pregelatinized) and mixtures thereof in all proportions for use on nut-based plant-based milks. Other texture agents can also be used such as konjac gum.

Table 1 below shows combinations to obtain different textures of fermented products including fermented milks, yogurt drinks and stirred yogurts from almond milk.

TABLE 1

| | | Concentration | | | | | |
|---|---|---|---|---|---|---|---|
| | | (g texturant/ | | | Phases after | Homogeneity | Type of product |
| Drink | Gum | 100 ml of milk) | pHi | pHf | fermentation | after mixing | obtained |
| Almond | Guar | 0.10% | 8.62 | 5.13 | 2 | Heterogeneous | |
| | Guar | 0.25% | | 4.81 | 2 | Homogenous | Fermented milk |
| | Guar | 0.50% | | 4.48 | 1 | Homogenous | Yogurt drink |
| | Guar | 1% | | 4.46 | 1 | Homogenous | Stirred yogurt/ |
| | | | | | | | firm yogurt |
| | Konjac | 1% | 8.42 | 4 | 1 | Homogenous | Stirred yogurt/ |
| | | | | | | | firm yogurt |
| | Starch | 2% | 8.75 | 4.36 | 1 | Homogenous | Yogurt drink |
| | C*H\|FORM | | | | | | |

It is advantageously possible to use a guar gum/starch mixture in amounts that are adjusted according to the desired texture.

Table 2 below is a synthesis of texturants, or combinations thereof, and the texturant rates used that have been experimentally validated to obtain textures corresponding to three different types of fermented products from plant-based milks, based on nuts, and after yogurt maker fermentation with 2 g/l of ferments. The percentages are indicated in grams of texturant in relation to 100 ml of plant-based milks (%).

TABLE 2

| Type of product obtained | 1^{st} texturant | 2^{nd} texturant |
|---|---|---|
| Fermented milk | Guar 0.25%-0.38% | |
| | Konjac 0.1% | |
| | Starch 1%-1.5% | |
| Yogurt drink | Guar 0.5% | |
| | Guar 0.2%-0.5% | Starch 0.5%-2% |
| | Guar 0.38%-0.5% | Konjac 0.1% |
| | Guar 0.25%-0.5% | Tara 0.5% |
| | Konjac 0.1%-0.25%+ | Starch 1.5% |
| | Tara 0.25%-0.38%+ | Starch 1.5% |
| | Starch 2% | |
| Stirred yogurt | Guar 0.5% | Tara 0.5% |
| | Guar 0.5% | Konjac 0.25% |
| | Guar 0.5-0.6% | Starch 1.5%-2.5% |

The texture agents have their effect on the homogeneity and the texture of the fermented plant juice as soon as the ferment+texture agent composition is added, but especially during the fermentation process. Thus, the texture in the minutes following the addition of the preparation and the texture resulting from the fermentation phase are not similar, showing the synergy of the texture agents and the fermentation to obtain the desired texture.

The kit according to the invention is advantageously accompanied by a set of instructions or a recipe book that identifies the amounts of ferment and of texture agent to be used per volume of plant-based milk. These amounts of ferment and of texture agent to be used will be defined in relation to the plant-based milk to be fermented and to the type of fermentation product sought.

The amount of texture agents will preferably be less than 3 g of texture agents per 100 ml of plant-based milk. Advantageously, it will be between 0.1 g and 3 g of texture agents per 100 ml of milk to be fermented, the amounts depending on both the consistency of the fermentation product and the nature of the texture agent or mixture of texture agents used.

For a fermentation product of the fermented milk type, from 0.1 to 2 g of texture agents per 100 ml of plant-based milk, in particular from 0.1 to 1.5 g of texture agent, in particular from 0.1 to 0.5 g, will advantageously be used. The texture agent content will depend on the texture agent used. For example, from 0.1 to 0.5 g of guar gum per 100 ml of plant-based milk, advantageously from 0.1 to 0.3 g, will be used. According to another embodiment of the invention, from 0.1 to 2 g of starch (preferably modified or pregelatinized for cold dissolution), preferably from 0.1 to 1.5 g, will be used. The skilled person will know how to adapt the amounts of texture agent for a mixture of said agents, in particular for a mixture of guar gum and starch.

For a fermentation product of the yogurt drink type, from 0.1 to 2 g of texture agents per 100 ml of plant-based milk, in particular from 0.1 to 1.5 g of texture agent, will be used.

For a fermentation product of the stirred yogurt type, from 0.5 to 3 g of texture agents per 100 ml of plant-based milk will be used.

Finally, fora fermentation product of the firm yogurt type, more than 1.5 g of texture agent per 100 ml of plant-based milk will be used.

According to a preferred embodiment of the invention, the texture agent is a mixture of guar gum and starch as previously defined. The guar gum/starch weight ratio is generally from 0.1 to 3.

It can be adapted according to the texture of the fermented product to be obtained.

For the texture of a yogurt drink, it generally ranges from 0.1 to 0.3.

For the texture of a stirred yogurt, it generally ranges from 0.2 to 0.3.

For the preparation of a yogurt drink, from 0.15 to 0.45% of guar gum, particularly from 0.2 to 0.4% of guar gum, in particular from 0.2 to 0.3% and from 1 to 2.4% of starch, particularly from 1.5 to 2% of starch, will be used.

For the preparation of a stirred yogurt, from 0.4 to 0.7% of guar gum, particularly from 0.5 to 0.6% of guar gum and from 1.5 to 2.8% of starch, particularly from 2 to 2.4% of starch will be used. The percentages are given in grams per 100 mL of plant-based milk to be fermented.

The amounts of ferments used for the production of fermentation products from plant-based milks are the same as for cow's milk. The amount of ferments depends on the species and strains used as well as the processes of their production and preparation.

The fermentation kit according to the invention will comprise the ferments and the texture agents in amounts suitable for home use.

For example, for a single-dose kit (obtaining a 125 ml yogurt), the amount of texture agents will preferably be between 0.25 g and 3.75 g for 125 ml of plant-based milk.

For a multi-dose kit, taking into account the home uses of yogurt maker and the particular problems of preservation of products for food use, the amount of texture agents will be 1.25 and 15 g per 500 ml of plant-based milk.

The invention also relates to a process for preparing a plant-based milk fermentation product which comprises the steps of a) adding the ferments and the texture agent(s) miscible with water at a temperature of 10° C. to 30° C. in a single step to an appropriate amount of plant-based milk, then b) distributing the mixture obtained in containers suitable for the yogurt maker fermentation step, step a) of mixing being carried out at room temperature and the amount of texture agent is comprised from 0.1 g to 3 g of texture agent per 100 ml of fermented milk.

By mixing at room temperature it is understood that the mixing is done without the need for heating between the addition of the texturants and the addition of the ferments.

The addition of other ingredients is not necessary to obtain the desired textures but can be used by the consumer to adjust to his or her tastes.

For its implementation, the ferments and the texture agents adapted to the desired fermented products are incorporated in the same preparation. This preparation can then be mixed directly into the plant-based milk or a premix can be made in a small volume of plant-based milk before integration into a larger amount of plant-based milk. The mixing can be done in a container whose size is adapted to the volume prepared and using a utensil such as a spoon or a whisk to disperse the powder in the plant-based milk.

Advantageously, the ferments and the texture agents are added simultaneously.

The principle of this mixing is that it is carried out at room temperature without the need for heating or sequential addition between the additives and the ferments. The mixing time can vary from a few seconds to several minutes depending on the volume. There is no advantage to mixing for longer than 1 min for small volumes (1 liter of juice).

After total dispersion of the mixture in the plant-based milk, the mixture can be distributed among the different containers, pots, jars or bottles in which the fermentation in individual portions will take place in the home yogurt maker. These containers are then placed in the fermentation conditions adapted to the ferments used and for a duration adapted to the desired fermented product. It is understood that the consumer may use any container and any device appropriate for home fermentation, without necessarily using a commercial yogurt maker.

The fermentation temperature is generally from 35° C. to 45° C. adapted to the ferments used. It is for example 37° C. or 42° C. for the species Streptococcus thermophilus and Lactobacillus delbrueckii bulgarii, the most commonly used.

The duration of fermentation will depend on the desired consistency of the fermentation product and the ferments used. Usually, a yogurt maker dairy fermentation lasts between 6 and 12 h. For some specific preparations, in particular fermented milk or kefir type products, it is possible to have a fermentation time of 12 h to 24 h at room temperature.

In order to obtain liquid and stirred yogurt type products, the jars or bottles can be put into a traditional home yogurt maker and the traditional yogurt program can be launched. For yogurt makers that allow a more refined programming, the fermentation practices known to the person skilled in the art can be applied. At the end of the fermentation process, the fermented products obtained are conventionally deposited and kept in a refrigerated location in order to stabilize the product. The same is true for the products obtained with our invention.

Home yogurt makers are well known, commercially available for the preparation of mammalian milk fermentation products. These products are marketed by a number of household appliance brands such as SEB, PROLINE, CUISINART, LAGRANCE, etc. They have long been known, for example described in a patent U.S. Pat. No. 2,052,253 from 1936. They generally comprise a set of fermentation containers that will receive the mixture of fermented milk with the ferments and texture agents in which fermentation will take place. These individual containers are generally adapted to store the fermentation product prior to use. Yogurt makers also comprise a fermentation tank in which the fermentation containers are placed for the duration of the fermentation step b). Finally, the yogurt maker comprises heating means and control means to regulate the heating of the fermentation tank for the duration of this step.

The process according to the invention is preferably implemented with the fermentation kit according to the invention.

The invention also relates to a home yogurt maker+fermentation kit set and its use for the preparation of plant-based milk fermentation products.

The invention also relates to the use of ferments and texture agents as previously defined for the preparation of plant-based milk fermentation products.

### EXAMPLES

The following examples were made with traditional Streptococcus thermophilus and Lactobacillus bulgaricus ferments marketed under the ALSA brand “mon yaourt maison”. They have also been reproduced with ferments produced on a plant basis marketed under the brands Danisco® VEGE Culture (Dupont) or NU-TRISH® (Chr Hansen). They can also be reproduced with all other available ferments, in particular certified “organic” or “vegan” ferments. The amounts of ferments are given in the examples for traditional ferments marketed under the ALSA brand. These amounts can be adapted if other ferments are used, such as ferments produced on a plant basis.

Fermented Milk

The demonstration is carried out with 0.12-0.48 grams of guar gum to which is added 0.25 g of ferment in 125 ml of plant-based milk (such as for example almond, cashew, hazelnut or coconut based) and with a yogurt maker cycle of 10 h. A similar result can also be obtained with other cold-soluble gums (konjac, tara, xanthan), but in different percentages or combinations of gums. A higher concentration of pregelatinized or modified starches can also be used (about 1%) alone for the same type of result.

Liquid Yogurt

To obtain a liquid yogurt-like product, a dosage comprised between 0.25 and 0.87 g of guar gum can be used in combination with 0.25 g of ferment in 125 ml of plant-based milk (such as for example almond, cashew, hazelnut or coconut based) and with a yogurt maker cycle of 10-12 h.

A liquid yogurt result can also be obtained with other gums in different percentages (depending on the supplier and quality), or thanks to combinations of gums, and with pregelatinized or modified starches (around 1-1.5%). Combinations between gums and between pregelatinized (or modified) gums and starches are also possible. In this case the starch has a role in adjusting the texture to the consumer's taste.

Stirred Yogurt

To obtain a stirred yogurt-like product, amounts of guar gum between 0.5 and 1.25 g can be used alone or in combination with modified or pregelatinized starches, or plant proteins to adjust the texture at the margin, and with 0.25 g of ferment in 125 ml of plant-based milk (such as for example almond, cashew, hazelnut or coconut based) and with a yogurt maker cycle of 10-12 h.

A stirred yogurt result can also be obtained with other gums in different percentages (depending on the supplier and quality) or with combinations of gums or other gums in combination with modified or pregelatinized starch.

Current modified or pregelatinized starches alone cannot be used to obtain a stirred yogurt texture unless they are used in amounts of the order of 6.25 g per 125 ml of milk, which are less advantageous to use than gums (around 0.6-1.25 g %). In our case stirred yogurts could be obtained with a combination of guar gum/konjac gum at 0.31 grams each or guar gum alone at 0.6 grams in combination with modified starches at 1.25 g or 2.5 grams and with 0.25 g of traditional ferment in 125 ml of plant-based milk followed by a yogurt maker cycle of 10 h.

Firm Yogurt

To obtain firm yogurt-type products, the gums must be used at a concentration higher than 1.8 g alone or in combination with proteins or starches to adjust to the desired texture. This amount is added to 0.25 g of traditional ferment in 125 ml of plant-based milk followed by a yogurt maker cycle of 10-12 h.

1. A fermentation kit for the home preparation of plant-based milk fermentation products comprising ferments and at least one texture agent, wherein the texture agent is miscible in water at a temperature of 10° C. to 30° C.

2. The fermentation kit according to claim 1, wherein the ferments and the texture agents are in individual packages.

3. The fermentation kit according to claim 1, wherein the ferments and the texture agents are packaged together as a premix.

4. The fermentation kit according to claim 1, wherein the fermentation kit also comprises a plant-based milk.

5. The fermentation kit according to claim 1, wherein the ferments are selected from the microorganisms of the genera Lactobacillus, Bifidobacterium, Lactococcus, Leuconostoc, Pediococcus, Propionibacterium and Streptococcus.

6. The fermentation kit according to claim 1, wherein the ferments are selected from ferments produced on a plant base.

7. The fermentation kit according to claim 1, wherein the texture agents are miscible in water at a temperature below 25° C.

8. The fermentation kit according to claim 1, wherein the texture agents are selected from cold-soluble gums, cold-soluble starches, cold-soluble plant proteins and mixtures thereof.

9. The fermentation kit according to claim 1, wherein the texture agent comprises at least one cold-soluble gum and/or cold-soluble starch in any proportion.

10. The fermentation kit according to claim 1, wherein said cold-soluble gum is guar gum.

11. The fermentation kit according to claim 10, wherein the guar gum/starch weight ratio ranges from 0.1 to 3.

12. A process for preparing a plant-based milk fermentation product which comprises the steps of:
a) adding the ferments and the texture agent(s), wherein the texture agent(s) is miscible with water at a temperature of 10° C. to 30° C. to a suitable amount of plant-based milk,
b) distributing the mixture obtained in step a), the mixture comprising ferments and texture agent(s), in containers suitable for the yogurt maker fermentation step, and
c) fermenting,
wherein step a) is carried out at room temperature, and the amount of texture agent is from 0.1 g to 3 g of texture agent per 100 ml of plant-based milk.

13. The process according to claim 12, wherein the ferments and the texture agents are added simultaneously to the plant-based milk.

14. The process according to claim 12, wherein the plant-based milks are selected from quinoa, rice, sesame, almond, coconut, cashew nut, oat, hemp, hazelnut, millet, chestnut, spelt, buckwheat, brazil nut and chickpea milks, and mixtures thereof.

15. The process according to claim 12, wherein the process is carried out with a fermentation kit according to claim 1.

16. The process according to claim 12, wherein the texture agent comprises guar gum, starch and mixtures thereof in any proportion.

17. The process according to claim 16 wherein the texture agent comprises from 0.1 to 0.3% of guar gum and/or from 0.1 to 2% of starch, the percentages being in grams per 100 mL of plant-based milk, and wherein the fermentation product has the consistency of a fermented milk.

18. The process according to claim 16, wherein the guar gum/starch weight ratio is from 0.1 to 3.

19. The process according to claim 16, wherein the guar gum/starch weight ratio ranges from 0.1 to 0.3 and wherein the fermentation product has the texture of a yogurt drink.

20. The process according to claim 19, wherein the texture agent comprises from 0.15 to 0.45% of guar gum and from 1 to 2.5% of starch, the percentages being in grams per 100 mL of plant-based milk.

21. The process according to claim 16, wherein the guar gum/starch weight ratio ranges from 0.2 to 0.3, and wherein the fermentation product has the texture of a stirred yogurt.

22. The process according to claim 21, wherein the texture agent comprises from 0.4 to 0.7% of guar gum and from 1.5 to 2.8% of starch, the percentages being in grams per 100 mL of plant-based milk.

23.-28. (canceled)

29. The fermentation kit according to claim 1, wherein the said fermentation kit further comprises a set of instruction or a recipe book identifying the amounts of ferments and the amounts of texture agents to be used per volume of plant-based milk.
